(19) United States
(12) Patent Application Publication
(10) Pub. No.: US 2003/0192824 A1
(43) Pub. Date: Oct. 16, 2003

(54) Straining apparatus and method of use

(76) Inventors: Anita Marriott, Yelm, WA (US); Victor J. Marriott, Yelm, WA (US)

Correspondence Address: Brian C. Kunzler, Suite 425, 10 West 100 South, Salt Lake City, UT, 84101, US

(21) Appl. No.: 10/378,774

(22) Filed: Mar. 4, 2003

Related U.S. Application Data
(63) Continuation-in-part of application No. 10/123,738, filed on Apr. 16, 2002.

(51) Int. Cl. B01D 35/28

(52) U.S. Cl. 210/470; 210/474; 210/498; 210/767

(57) ABSTRACT

A straining apparatus is provided for a supporting and balancing a container to strain liquid from solid food. Specifically, the straining apparatus comprises a base plate, a plurality of holes formed in the base plate, and a plurality of support members. The support members are formed to act as a brace in supporting the straining apparatus over an opening in a container. A handle and a protective steam fin may also be connected to the base plate. The fin reduces exposure to harmful steam during straining of food. The straining apparatus may also include magnets which facilitate removal of metal coverings of the container. The straining apparatus provides a balanced handling of heavy containers during straining. In addition, a method of engaging and straining a container such as a can is also provided.

### RELATED APPLICATIONS

This application is a continuation-in-part of and claims priority to U.S. patent application Ser. No. 10/123,738, filed on Apr. 16, 2002 and entitled “Food Liquid Strainer for Cooking,” which is incorporated herein by reference.

### BACKGROUND OF THE INVENTION

1 The Field of the Invention

The present invention relates to devices that aid in separating liquids from solids and more particularly containers that strain liquids from solid foods by engaging a lip or edge of the container.

2. The Relevant Art

Ever since containers have been used to cook food, food preparation has required the removal of liquid from solid food before emptying the food contents from the container. This simple act of straining a liquid from a solid, involves a number of hazards capable of causing injury. For example, when food is boiled, hot steam rises from the pot. When the water is poured out of the pot, the user's arms and hands may be exposed to the dangerous steam. Even if a conventional strainer is used, the user is still exposed to the hot steam. In addition, if a typical strainer with no support members is used, the strainer must be held over the pot while the user holds the pot handle. This is typically awkward and can cause the user to drop the pot or its contents, especially as the weight of the pot shifts. Many conventional strainers provide no support for the pot during straining making it difficult for a user to strain the contents of a pot without dropping the pot. Other strainers include two handles or tabs which protrude on either side of the pot. Holding the pot while gripping both sides of theses strainers is also awkward and may cause a user to burn him/her self from contact with the heated pot.

Additionally, there is the problem of balancing the pan when a user tips it over to pour the liquid contents out to separate it from solid food contents. For example, a typical pan includes a single long handle; filling the pan full of hot grease and heavy meat and tipping the pan over with only the thin handle requires a great deal of strength in the hands and arms. If a user lacks the required strength, there is a risk of dropping the pan and spilling hot grease and food onto the user. Add to this process the difficulty of holding a strainer, and it is understandable why every year, literally tens of thousands of cooks are injured due to dropped pots and pans.

Another problem with using liquid strainers is that one strainer often does not fit effectively over many sizes of pots and pans. Where there is not a good fit between the two devices or the strainer does not support or engage the pot, the strainer can slide off the pot or pan, causing the food to pour down the drain, the pot to be dropped, or the user to be injured.

One conventional food strainer is a cooking utensil in the form of a pan having upstanding walls and a lid or cover supportable by the upper edges of the walls and which is dimensioned to fit into the interior of the pan for use as a food scoop or spatula. The cover is generally planar and perforated, enabling its use as a sieve for the draining of cooking fluids from food supported thereon and as a porous cover which promotes condensation of cooking vapors for basting the food being cooked in the pan.

Another straining device is a detachable food straining screen having lower and upper peripheral grooves for pressure fitting engagement with the top of a cooking pot and the bottom of a corresponding cover for the pot.

Yet another straining device is adapted to fit over an opening of a variety of food storage and preparation containers. These strainers involve a flexible matrix, a flexible cord which is slidably disposed within a conduit, that is located along the perimeter of the matrix and has an opening through which the ends of said cord protrude, and a means for releasably engaging the ends of the cord. After the strainer is placed over the opening of the container, the ends of the cord are pulled through the engaging means to adapt the circumference of the conduit to that of the container.

Another conventional straining device is slidably inserted into a steam table pan as found in commercial restaurant, catering, and hotel applications. The steam pan manipulation device features apertures of an appropriate size, so that the device may also be used as a strainer for separating liquid from the content of the tray while retaining solid content in the tray. The device separates solids and liquids and allows a worker to safely carry a tray full of liquid without sloshing, because the center of gravity of the liquid is lower than the point of carrying.

Despite the advances made by conventional straining devices in the area of food straining, a need still exists for a straining device that can be used to grip and engage containers of different sizes and shapes securely to safely strain the contents of the strainers.

### BRIEF SUMMARY OF THE INVENTION

The apparatus and method of the present invention has been developed in response to the present state of the art, and in particular, in response to the problems and needs in the art that have not yet been fully solved by currently available devices or methods.

In one aspect of the invention, a device is provided that securely engages a lip or edge of a container. Specifically, a plurality of double curved support members of the device securely engages a plurality of container sizes. A base connected to the double curved support members provides engagement and a balanced handling of a container during straining.

A handle is connected to the base proximal to the back edge of the base and extending above the plane of the base. A fin or shield may be positioned proximal to the handle and connected to the base proximal to the back edge. The fin may extend below the bottom surface of the base and the handle. Preferably the fin is positioned such that a center line of the fin aligns with a center line of the base. At least one double curved support member is positioned along the curved edge of the base.

In one embodiment, the base includes a curved front edge with generally straight side edges and a straight back edge. Alternatively, the base may comprise two straight edges that intersect at a ninety-degree angle to form the front edge and a straight back edge such that the base has a generally triangular shape. The triangular embodiment is adapted to engage a container having a corner.

In certain embodiments, the handle and fin extend at an angle that ranges from about 10 degrees to about 155 degrees. Of course, the handle and fin may extend at other angles.

The double curved support member is connected to the base to receive a lip or edge of a container. The support member includes a first curve and a second curve. In one embodiment, the first curve rises slightly above the plane of the base such that the base is positioned below a container lip or edge when engaging the container. The first curve continues downward, and the second curve extends from the first curve in an opposite direction to ultimately extend the support member downward and away from the base. The base preferably includes a plurality of holes formed to allow liquid to escape from the container. In one embodiment, the front edge of the base forms an arc and the side edges form parallel edges.

In one aspect, a planar resizing sheet may be positioned along side the base plate. The planar sheet may include a plurality of holes which are smaller than holes formed in the base plate. The holes may serve to retain solid particles which are small enough to pass through the holes of the base plate.

In another aspect, a tooth may be connected to the base plate. The tooth may extend substantially downward from a plane defined by the base plate. The tooth may be configured to bias a lip of a container between the tooth and one or more support members connected to the base plate. Preferably, the tooth is positioned at about the center of the front edge of the base plate. In certain embodiments, a pair of support members may be positioned such that the tooth is evenly positioned between the two support members.

The container engaging may be made of a heat resistant material or a heat transmitting material, or a combination of both.

### BRIEF DESCRIPTION OF THE DRAWINGS

The present invention will be understood more fully from the detailed description given below and from the accompanying drawings of the preferred embodiment of the invention, which, should not be construed to limit the invention, but are for illustration only.

FIG. 1 illustrates a top view of one embodiment of the present invention.

FIG. 2 illustrates a top view another embodiment of the present invention.

FIG. 3 illustrates a perspective view of one embodiment of the present invention.

FIG. 3a illustrates an upside down rear side view of the embodiment of FIG. 3

FIG. 4 illustrates a side view of a support member.

FIG. 4a illustrates another embodiment of the support member.

FIG. 5 illustrates a side view of one embodiment of the present invention.

FIG. 5a illustrates a top view of a planar resizing sheet of one embodiment of the present invention.

FIG. 6 illustrates a side view of a support member which includes a cushioning covering.

FIG. 7 is a flow chart of one embodiment of a method of straining a container under the present invention.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the accompanying drawings.

### DETAILED DESCRIPTION OF THE INVENTION

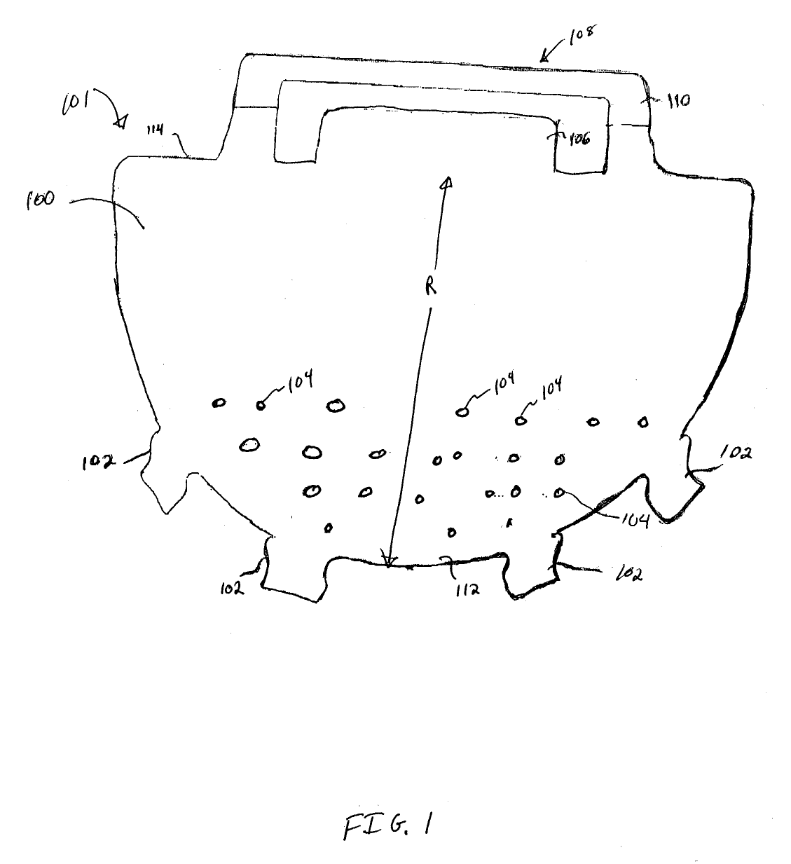

FIG. 1 depicts a straining apparatus 101 of the present invention. In the depicted embodiment, the straining apparatus 101 comprises a base plate 100 from which a plurality of support members 102. In one embodiment, the support members extend from the plane of the base plate 100 and curve downward to engage the base plate 100 with a container. The base plate preferably includes a plurality of holes 104 to allow fluid to be strained from any solids inside the container. A handle 108 and a protective steam fin 106 are shown extending from the back edge 114 of the base plate 100 in the depicted embodiment. Of course, the handle 108 and the protective steam fin 106 are optional, and if present may be configured in any suitable manner.

In one embodiment, the handle 108 may be partially covered with an insulating coating 110 to protect a user's hand from heat conducted by the straining apparatus 101 and to provide comfort in using the handle 108. The steam fin 106 is in one embodiment positioned and sized to divert steam within the container away from the user's hand. The straining apparatus of the present invention may be configured in various manners suitable for straining fluid from a container such as a pot, pan or can.

The handle 108 may be positioned along a back edge 114 of the base plate 100. Preferably, the handle 108 is U-shaped. The handle 108 may be positioned such that the middle of the handle 108 substantially aligns with the center of the front edge 112. Such a positioning of the handle enables a user to balance the center of gravity of the container as the liquid is expelled.

Preferably, the handle 108 extends from the back edge 114 at an angle. The size of the angle is not critical to the present invention. In one embodiment, the angle is about forty-five degrees. Consequently, the angle of the handle 108 is such that when the container is tipped into almost a horizontal position, the handle 108 extends almost vertically. Thus, the angle of the handle 108 may further assist a user in manipulating the container during straining.

In the straining apparatus 101, a front edge 112 of the base plate 100 may be curved to allow the support members 102 to engage a pan or other container with a rounded shape. It is anticipated that the straining apparatus 101 is configured to hold a container with a diameter ranging from about 4 inches to about 14 inches. Of course the straining apparatus 101 may be sized to accommodate a variety of container sizes.

The straining apparatus 101, as depicted in FIG. 1, is an example of a base plate 100 with a curved front edge 112 and a plurality of support members 102 connected to the base plate 100. Preferably, the support members 102 are evenly disposed on each side of the center of the front edge 112. In this manner, the support members 102 provide balanced support for the container during straining. In addition, evenly distributing the support members 102 limits the tendency for the container to roll to one side during straining.

The support members 102 are in one embodiment configured to support the weight of a container as the container is tipped for straining liquid from the container. Therefore, the support members 102 are preferably made from strong materials such as metal, hard plastics and the like. While our support members 102 are shown, more or less than four may be used.

In selected embodiments, the support members 102 are configured to engage a wide variety of containers including, but not limited to, pots, pans, mixing bowls, buckets and the like. Referring to FIG. 1, the radius R around the curvature of the front edge 112 and the position of the support members 102 allow the present invention to engage containers of a variety of sizes. For example, a straining apparatus 101 with a radius R of about 12 inches is capable of engaging containers which range in size between about 12 inches in diameter to about 8 inches in diameter.

The number, size, position, and pattern of the holes 104 may vary. For example, a straining apparatus 101 used exclusively for small pasta or rice, may include holes closer together and closer to the front edge 112. Alternatively, for large solids, the holes 104 may be larger and further spaced apart.

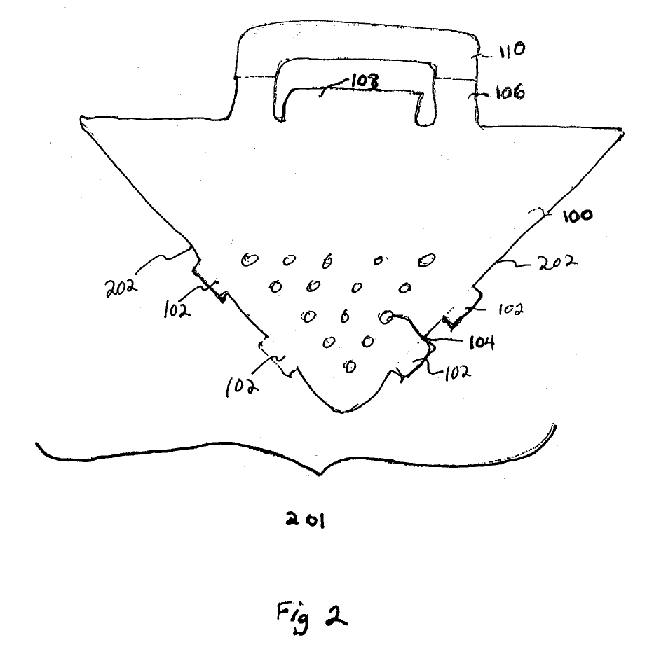

FIG. 2 depicts another embodiment of the straining apparatus 201 configured to engage a container having a corner. The straining apparatus 201 includes many of the features of the straining apparatus 101 of FIG. 1. In particular, the straining apparatus 201 in the depicted embodiment includes a base plate 100, a plurality of support members 102, a plurality of holes 104 formed in the base plate 100, a steam fin 106, a handle 108, and an insulating coating 110 covering part of the handle 106. Unlike the straining apparatus 101, the straining apparatus 201 is substantially triangular shaped to allow the straining apparatus 201 to engage almost any size container having a corner.

The shape of the base plate 100 is not critical to the shape of the straining apparatus 101, 201. Thus, while a semi-circular and triangular straining apparatus 101, 201 are described in detail, those of skill in the art will readily understand that the base plate 100 may be of almost any shape, including any geometric or oval shape. In addition, the base plate 100 may be of any operable size for engaging a variety of containers.

The straining apparatus 201 includes a base plate 100 that has two edges 202 that intersect to substantially form a right angle. Consequently, the straining apparatus 201 is able to engage with a container that has two straight edges that meet to form a corner. In certain embodiments, the straining apparatus 201 includes four support members 102, two support members on each edge 202. Alternatively, the straining apparatus 201 may include more or less than four support members 102. Preferably, an equal number of support members 102 are positioned along each edge 202.

The various embodiments of the straining apparatus 101 are capable of engaging almost any kind of container commonly used in culinary activities. Examples of such containers include, but are not limited to, containers with or without a lip on the edge, glass, plastic, metal or metal coated containers, pots, pans, Dutch ovens, and the like, as well as cans or other containers commonly used in cooking.

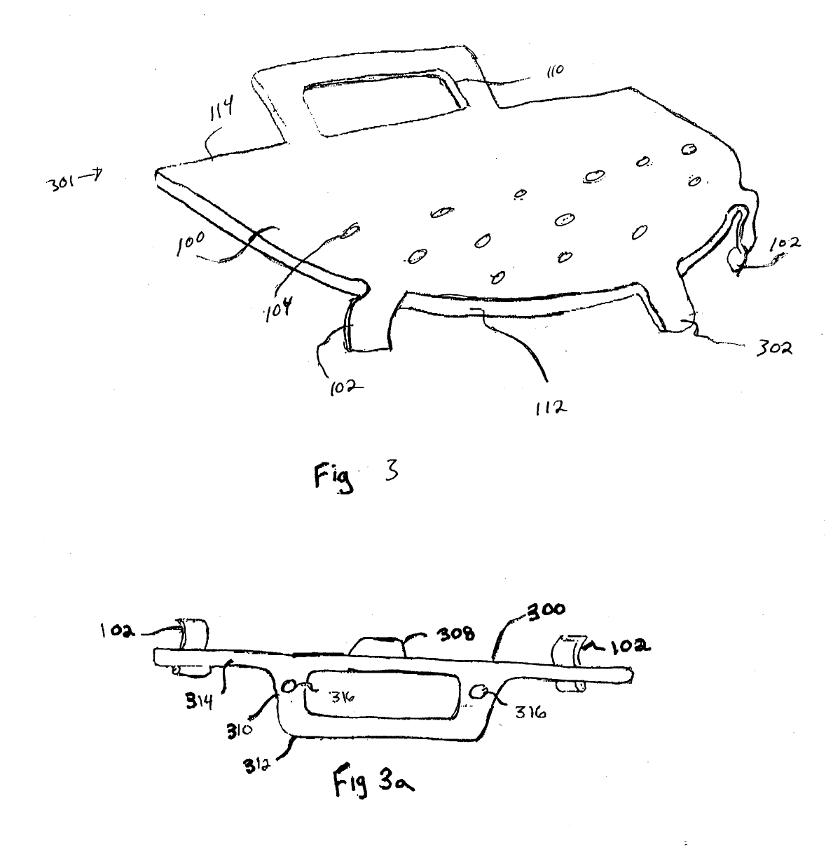

FIG. 3 illustrates a perspective view of another embodiment of a straining apparatus 301 that includes a plurality of support members 102 and a tooth 302. Preferably, the plurality of support members 102 are connected to the front edge 112 of the base plate 100. The tooth 302 is positioned approximately in the center of the base plate's front edge 112. In the depicted embodiment the tooth 302 extends downward and slightly away from the plane of the base plate 100. Preferably, a support member 102 is positioned on both sides of the tooth 302 such that the tooth 302 is disposed about in the middle of the two support members 102. The tooth 302 preferably cooperates with one or more of the support members 102 to bias a wall of the container between the tooth 302 and the one or more support members 102. That is, when disposed between the tooth 302 and the support member 102, the container wall is substantially braced or pinched between the tooth 302 and the support members 102.

FIG. 3a illustrates an upside down rear side view of the straining apparatus 302. As depicted, the straining apparatus 301 includes optional magnets 316 connected to the bottom side of the handle 310. Alternatively, the magnets 316 may be connected to other parts of the straining apparatus 301. The magnets 316 aide in removing a lid of an opened can, and minimize injury to user from contact with the sharp edges of the lid. In addition, the magnets 316 minimize the risk of contamination posed by contaminants that may have aggregated on the external surface of a can lid. Preferably, the tooth 302 is substantially longer than the support members 102. Alternatively, the support members 102 may be longer than the tooth 302. In another alternative, the support members 102 and tooth 302 may be substantially the same length. Preferably, the tooth 302 extends below a plane defined by the base plate 100 such that the tooth 302 may be inserted into the container.

Preferably, the straining apparatus 301 is sized and shaped for use with cans of a particular size, which may include by way of example, a standard number 10 can. In one embodiment, the straining apparatus 301 is employed by engaging the support members 102 against the outside of a can by biasing the side between the support members 102 and the tooth 302 which is braced against the inside of the can. Alternatively, the tooth 302 may extend outside the can while the support members 102 are engaged within the can.

Generally, the tooth 302 is configured to engage the container wall and the support members 102 are configured to support the weight of the container during straining. Alternatively, the tooth 302 may be strong enough to also support the container weight. For example, in certain embodiments the tooth 302 may extend outside the container wall and the support members 102 may be configured to extend within the container wall.

The base plate 100, support members 102, tooth 302, handle 108, and steam fin 106 may be made from a variety of materials including metal, plastic, ceramic, and the like. Preferably, the material is rigid, durable, and resists rust. Furthermore, the base plate 100, support members 102, handle 108, and steam fin 106 may be separate components which are joined together to form the straining apparatus 101. Preferably, the base plate 100, support members 102, handle 108, and steam fin 106 are formed from a single piece of material such as metal. For example, the base plate 100, support members 102, tooth 302, handle 108, and steam fin 106 may be stamped from a single sheet of metal. Alternatively, the straining apparatus may be formed from molded plastic, ceramic or the like.

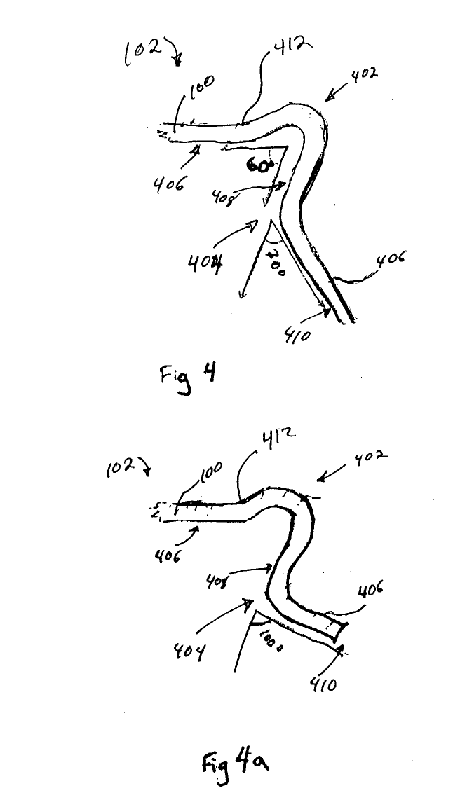

FIG. 4 illustrates a detailed view of the shape of a support member. In one embodiment, the support member 102 comprises a first curve 402 and a second curve 404. The first curve 402 may extend from the base plate 100 and initially extend from a position above a plane defined by the base plate 100. In one embodiment, the first curve 402 forms about a sixty-degree angle between the bottom surface 406 of the base plate 100 and the interior surface 408 of the first curve 402. The second curve 404 preferably extends from the first curve 402 and curves in a direction opposite the first curve 402. A third curvature 412 may also be present and may initially extend and orient the support member 102 upward from the plane of the base plate 100.

Preferably, the second curve 404 forms about a thirty-degree angle between the interior surface 408 of the first curve 402 and the interior surface 410 of the second curve 404. Together the first curve 402 and second curve 404 may substantially form a backwards “S” shape. In certain embodiments, the second curve 404 may then extend straight out to form a tab 406.

FIG. 4a illustrates an alternative embodiment of a support member 102. In FIG. 4a the second curve 404 forms about a one hundred degree angle between the interior surface 408 of the first curve 402 and the interior surface 410 of the second curve 404. Of course, the first curve 402 and second curve 404 may include a variety of arcuate sections within the scope of the present invention. For example, in one embodiment, the first curve 402 may not rise above a plane defined by the base plate 100 and may instead initially extend outward in parallel with the plane of the base plate 100.

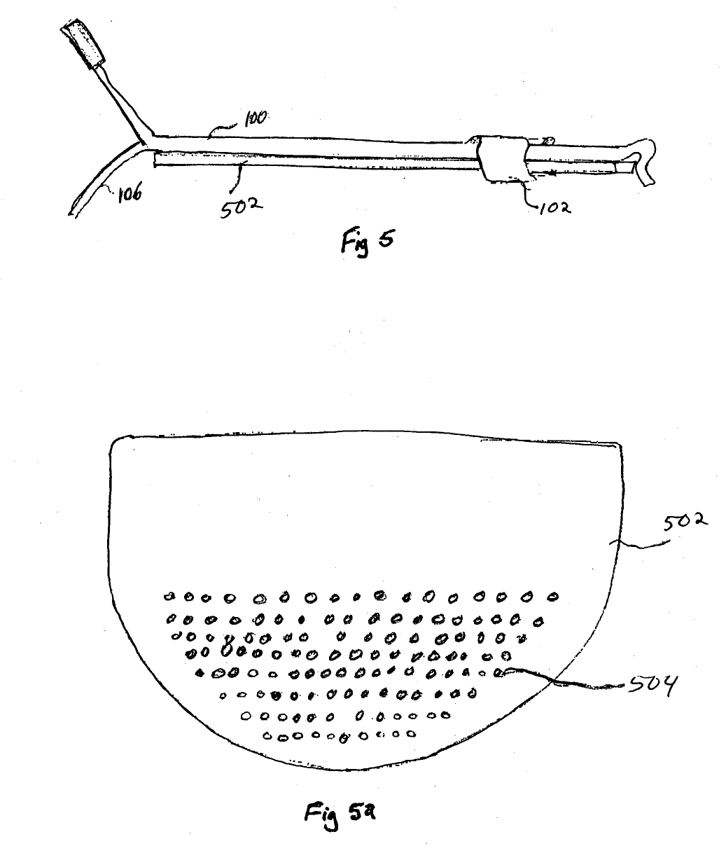

FIG. 5 illustrates one embodiment of the straining apparatus 101 which includes a planar resizing sheet 502. The planar resizing sheet 502 provides an additional level of straining for the solids within the container. Preferably, the planer resizing sheet 502 includes holes 504 (See FIG. 5a) which are smaller than the holes 104 in the base plate 100. The sheet 502 is configured to be retained next to the base plate 100. In one embodiment, the planer resizing sheet 502 is sized and shaped to rest against and be held in place by the support members 102. Alternatively, clips, channels or other temporary connectors may be used to retain the sheet 502 against the base plate 100. Thus, the planar resizing sheet 502 provides flexibility in selecting variously sized solids for which the straining apparatus 101 is capable of straining.

FIG. 5a illustrates on example of a shape of the planar resizing sheet 502. In this embodiment, the sheet 502 is shaped and sized to substantially match the shape and size of the base plate 100. As mentioned above, the holes 504 may be substantially smaller than the holes 104 in the base plate 100. Of course, the sheet 502 may be embodied in a variety of shapes. For example, the sheet 502 may comprise a rectangular member sized to fit over the area of holes 104 in the base plate 100. Alternatively, the sheet 502 may only cover a few rows of holes 104 in the base sheet 502.

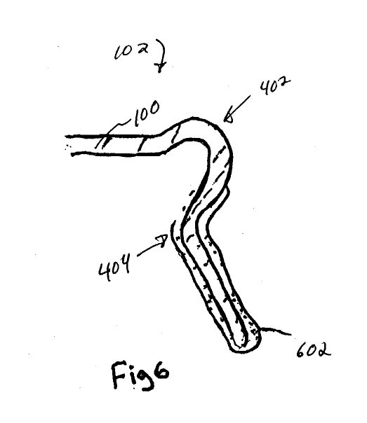

FIG. 6 illustrates an embodiment of the support member 102 which is covered with cushioning material 602. The cushioning material 602 may be made from rubber, plastic, or other pliable materials. Preferably, the cushioning material 602 increases the coefficient of friction between the support members 102 and the wall of the container. Thus, the ability of the support members 102 to engage the container may be enhanced by the cushioning material 602. The cushioning material 602 also provides a protective layer between the support member 102 and the container. This protective layer may protect against damage to containers such as more expensive pots and pans. In certain embodiments, the cushioning material 602 may be deposited over the fin 106. The cushioning material 602 may be heat resistant as well.

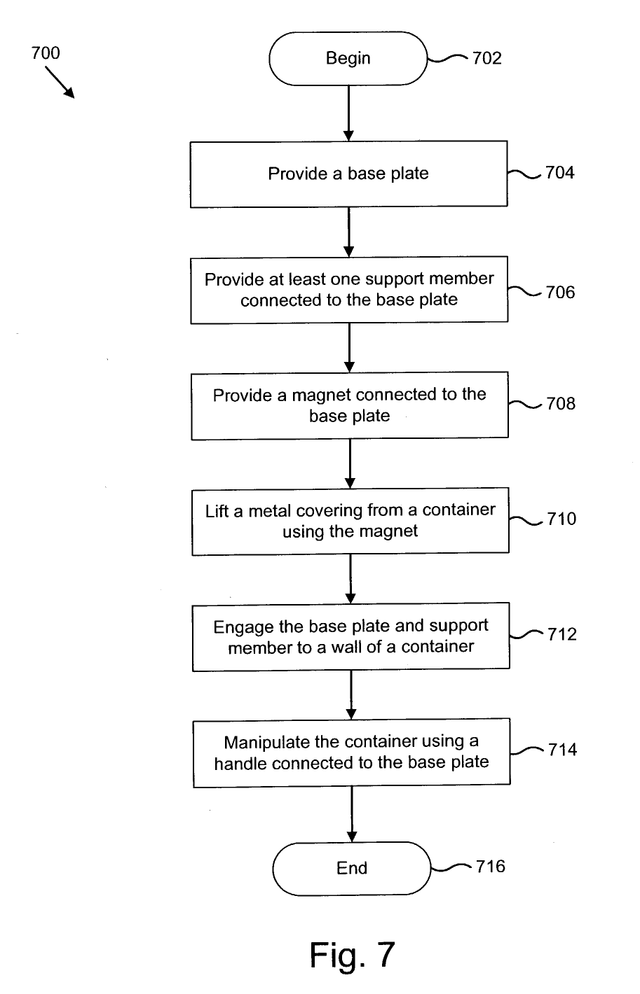

FIG. 7 is a flowchart 700 illustrating one embodiment of a method of the present invention for handling a container. First, a base plate 100 is provided 704. Next, one or more support members 102 is provided 706. The base plate 100 and support members 102 are preferably configured in a manner discussed above. In addition, a tooth such as the tooth 302 may be used to engage the container. A magnet 316 is also optionally provided 708. A metal covering of the container is in one embodiment lifted 710 using the magnet 316. The base plate 100 and support member 102 one also used to engage 712 the container. Finally, the container is manipulated 714 using a handle 108 connected to the base plate 100. The manipulation 714 may be straining, pouring, or other operations involving a container.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A straining apparatus comprising:
a base plate having a front edge and a back edge; and
at least one support member connected to the base plate for engaging a container in a selected position with respect to the base plate, the support member comprising at least a first curve and a second curve, the first curve curving in a generally downward direction with respect to the plane of the base plate and, the second curve curving in a direction generally downward and laterally away from the plane of the base plate.

1a. The apparatus of claim 1, wherein the support member initially extends upward and away from the plane of the base plate.

1b. The apparatus of claim 1, wherein the first curve orients the support member in a direction generally downward and laterally toward the plane of the base plate.

2. The apparatus of claim 1, wherein the front edge is curved.

3. The apparatus of claim 2, wherein a plurality of support members are disposed around the perimeter of the front edge.

4. The apparatus of claim 1, wherein the base plate comprises a substantially triangular shape.

5. The apparatus of claim 1, further comprising a plurality of holes formed in the base plate.

6. The apparatus of claim 1, further comprising a substantially planar sheet configured to be positioned proximal to the base plate, the sheet comprising a plurality of holes which are of a smaller diameter than the holes formed in the base plate.

7. The apparatus of claim 1, further comprising a tooth connected to the base plate near the center of the front edge, the tooth extending substantially downward from the plane of the base plate.

8. The apparatus of claim 7, wherein two support members are positioned such that the tooth is about evenly positioned between the two support members.

9. The apparatus of claim 8, wherein the tooth is configured to bias a wall of the container between the tooth and the two support members.

10. The apparatus of claim 1, further comprising a handle connected to the base plate, the handle curving away from the plane of the base plate and having an insulating material coating at least a portion of the handle.

11. The apparatus of claim 1, further comprising a magnet connected to the straining apparatus.

12. The apparatus of claim 1, further comprising a fin connected to the base plate, the fin curving away from the handle and extending below the plane of base plate.

13. The apparatus of claim 12, wherein the fin is coated with a cushioning material.

14. The apparatus of claim 1, wherein the first curve of the support member curves in one direction and the second curve curves in a direction opposite the direction of the first curve.

15. The apparatus of claim 1, further comprising a cushioning material coating the support member.

16. A straining apparatus comprising:
a base plate;
at least one support member connected to the base plate for supporting and engaging a container in a selected position with respect to the base plate, the support member comprising at least a first curve and a second curve, the first curve curving in a generally downward direction with respect to the plane of the base plate and, the second curve curving in a direction generally downward and laterally away from the plane of the base plate; and
a tooth connected to a front edge of the base plate, the tooth extending downward substantially away from the plane of the base plate.

17. The apparatus of claim 16, wherein the base plate comprises two parallel side edges joined by a curved front edge and a straight back edge.

18. The apparatus of claim 16, wherein the support member is connected to the curved front edge.

19. The apparatus of claim 16, further comprising a plurality of holes formed in the base plate.

20. The apparatus of claim 1, wherein the first curve of the support member curves in one direction and the second curve curves in an opposite direction of the first curve.

21. The apparatus of claim 16, further comprising a handle connected to the base plate, the handle extending away from a plane defined by the base plate, the handle comprising an insulating material coating over a portion of the handle.

22. The apparatus of claim 16, further comprising a magnet connected to the base plate.

23. A method of handling a container comprising:
providing a base plate;
providing at least one support member connected to the base plate for supporting and engaging a container in a selected position with respect to the base plate, the support member comprising at least a first curve and a second curve, the first curve curving in a generally downward direction with respect to the plane of the base plate and, the second curve curving in a direction generally downward and laterally away from the plane of the base plate; and
engaging the base plate and support member with a wall of a container.

24. The method of claim 23, further comprising providing the base plate with a handle having a magnet connected thereto and lifting a metal cover from the container with the magnet.

25. The method of claim 23, further comprising removing a metal cover from the container without allowing contact between an external surface of the metal cover and contents the of the container.

26. The method of claim 23, wherein the base plate comprises a tooth positioned proximal to the support member, the tooth biasing the wall of the container between the tooth and the support member.

27. The method of claim 23, further comprising providing the base plate with a plurality of holes and straining a fluid from the container through the holes.

28. The method of claim 23, further comprising disposing a sheet proximal to the base plate, the sheet comprising a plurality of holes, the holes of the sheet having a smaller diameter than the holes in the base plate.
